(19) United States
(12) Patent Application Publication
(10) Pub. No.: US 2013/0152157 A1
(43) Pub. Date: Jun. 13, 2013

(54) AUTOMATIC FILTERING IN SOCIAL NETWORKS

(71) Applicants: Candice L. Coletrane, Durham, NC (US); William G. Pagan, Durham, NC (US); Adam J. Parker, Cary, NC (US)

(72) Inventors: Candice L. Coletrane, Durham, NC (US); William G. Pagan, Durham, NC (US); Adam J. Parker, Cary, NC (US)

(73) Assignee: International Business Machines Corporation, Armonk, NY (US)

(21) Appl. No.: 13/324,563

(22) Filed: Dec. 13, 2011

(51) Int. Cl. G06F 21/00; G06F 15/173

(52) U.S. Cl. 726/1

(57) ABSTRACT

Embodiments of the present invention provide a method, system and computer program product for automated filtering of content viewing rights in a social network. In an embodiment of the invention, a method for automated filtering of content viewing rights in a social network includes selecting content directed for publication to different members of a social network executing in memory of a host server and computing a context for the content. The method additionally includes applying a rule to the context and to at least one member profile corresponding to one of the members of the social network in order to determine whether or not the content is to be blocked from viewing by the one of the members based upon a relationship between the member profile and the computed context. Thereafter, access to the content by the one of the members is permitted when permitted by the rule.

### BACKGROUND OF THE INVENTION

1. Field of the Invention

The present invention relates to social networking and more particularly to restricted content sharing in a social network.

2. Description of the Related Art

A social network refers to a social structure of nodes each associated with a different person or organization. The interconnections of each node reflect direct relationships between the respective people and organizations such that the directness of a relationship between two persons or organizations associated with respective nodes can be summarized by the path of interconnections between the respective nodes. In this way, any one individual in a social network can evaluate the number and quality of social relationships with others in the network, those relationships ranging from close familial bonds to casual acquaintances.

The advent of the global Internet has changed the way in which social networks can be viewed. Originally, a mere visual tool describing a social phenomenon, computerized social networks facilitate the recognition and expansion of social networks amongst interacting users across the globe. Whereas geographic boundaries previously limited the extent and quality of a given social network, the global Internet enables limitless expansion of the social network based upon a vast set of aware collaborators coupled by the fabric of computer communications.

Commercial computerized social networks have become wildly popular in recent years—especially amongst the younger demographic. Examples include the MySpace™ computer socialized network maintained by MySpace, Inc. of Los Angeles, Calif., LinkedIn™ computerized business network maintained by LinkedIn Corporation of Palo Alto, Calif., and the Facebook™ computerized social network maintained by Facebook of Palo Alto, Calif. Commercial computerized social networks represent social networking services connecting users according to different types of interests in an aggregated view—generally a Web site hosting user contributed content through imagery and commentary.

Integral to any social network is the sharing of content with other members of the social network. Traditionally, privacy controls can be established for different members of a social network that dictate which other individuals both inside and outside of one's contacts are able to access provided content. Typical examples include the directive that only those in a member's contact list can view content published by the member, or alternatively that content posted by a member can be viewed by everyone whether or not the viewer is a contact of the member.

Recently, the management of privacy controls in a social network have become overly complicated allowing members to partition access rights to content according to privacy groups. Maintaining privacy groups, however, can be tedious and manually intensive. Further, members of a social network frequently lose track of who has been associated with which privacy group and which privacy rights have been accorded to which privacy groups.

### BRIEF SUMMARY OF THE INVENTION

Embodiments of the present invention address deficiencies of the art in respect to privacy controls in a social network and provide a novel and non-obvious method, system and computer program product for automated filtering of content viewing rights in a social network. In an embodiment of the invention, a method for automated filtering of content viewing rights in a social network is provided. The method includes selecting content directed for publication to different members of a social network executing in memory of a host server and computing a context for the content. The method additionally includes applying a rule to the context and to at least one member profile corresponding to one of the members of the social network in order to determine whether or not the content is to be blocked from viewing by the one of the members based upon a relationship between the member profile and the computed context. Thereafter, access to the content by the one of the members is permitted when permitted by the rule.

In one aspect of the embodiment, the rule specifies that content of a political nature is to viewable by only those members sharing a political affiliation specified by corresponding profile information that is consistent with a political affiliation indicated by the context of the content. In another aspect of the embodiment, the rule specifies that content of an adult nature is to be viewable by only those members of an age specified by corresponding profile information that exceeds a minimum threshold age. In yet another aspect of the embodiment, the rule specifies that content of a profane nature is to be blocked from view by those members having a religious affiliation specified by corresponding profile information.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for automated filtering of content viewing rights in a social network;

FIG. 2 is a schematic illustration of a social networking data processing system configured for automated filtering of content viewing rights; and,

FIG. 3 is a flow chart illustrating a process for automated filtering of content viewing rights in a social network.

### DETAILED DESCRIPTION OF THE INVENTION

Embodiments of the invention provide for automated filtering of content viewing rights in a social network. In accordance with an embodiment of the invention, content selected for publication in a social network can be analyzed to determine a context of the content. In one aspect of the embodiment, the context can include a keyword included within or associated with the content. In another aspect of the embodiment, the context can include a keyword associated with a recognizable image in the content. The context in turn can be compared to one or more rules associated with a member of the social network to determine whether or not the content is to be blocked from viewing by the member. In yet another aspect of the embodiment, the rules can be individually specified for each member of the social network such that content published by one member of the social network can be selectively blocked for viewing for each contact in a contact list of the member according to rules corresponding to each contact in the contact list.

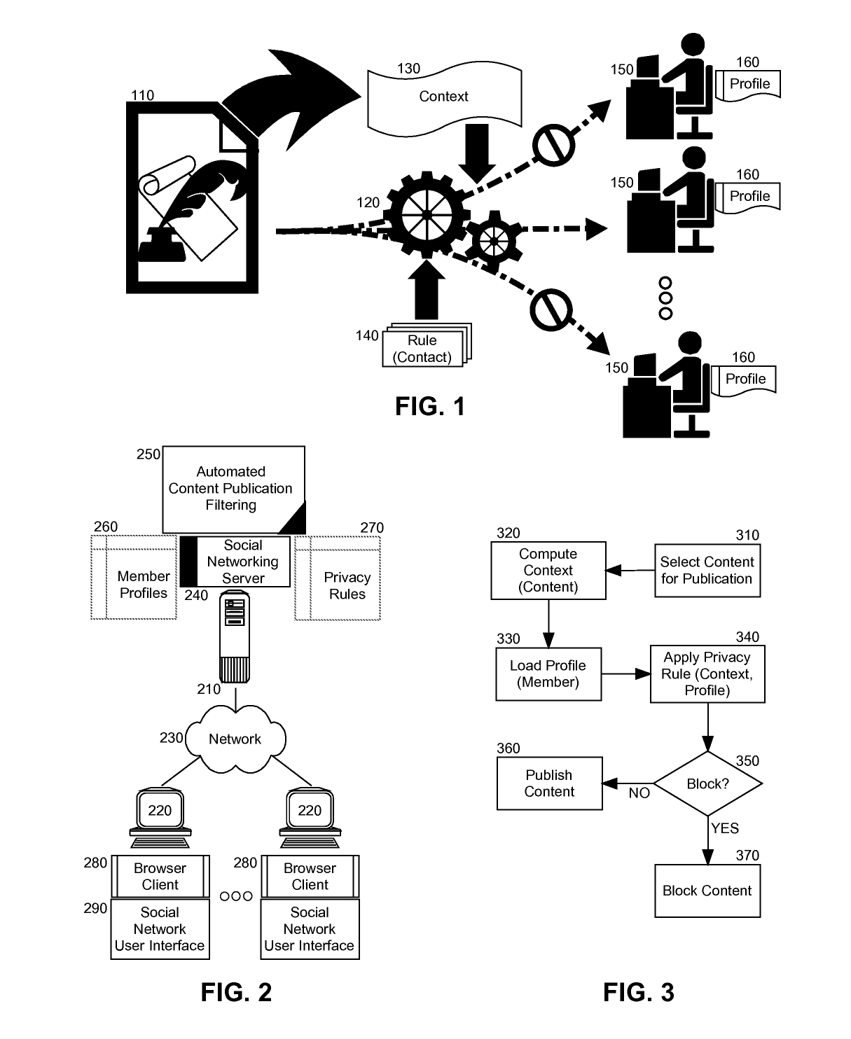

In further illustration, FIG. 1 pictorially shows a process for automated filtering of content viewing rights in a social network. As shown in FIG. 1, content 110 can be selected for publication to at least one member 150 of a social network. The content 110 can include text, an image, audio, video or any combination thereof. The context 130 of the content 110 can be determined, for instance by parsing text in the content 110, by speech recognizing audio in the content 110, or by image recognizing all or a portion of imagery in the content 110. Filtering logic 120 can compare the context 130 of the content 110 to one or more rules 140 specifying whether or not the content 110 is to be blocked from access by one or more of the members 150 according to profile information 160 for the members 150.

For instance, one of the rules 140 may specify that content 110 of a political nature is to viewable by only those members 150 sharing a political affiliation specified by corresponding profile information 160 that is consistent with a political affiliation indicated by the context 130 of the content 110. As another example, one of the rules 140 may specify that content 110 of an adult nature is to be viewable by only those members 150 of an age specified by corresponding profile information 160 that exceeds a minimum threshold age. As yet another example, one of the rules 140 may specify that content 110 of a profane nature is to be blocked from view by those members 150 having a religious affiliation specified by corresponding profile information 160. As even yet another example, one of the rules 140 may specify that content 110 of a religious nature is to viewable by only those members 150 sharing a religious affiliation specified by corresponding profile information 160 that is consistent with a religious affiliation indicated by the context 130 of the content 110.

The process described in connection with FIG. 1 can be implemented within a social networking data processing system. In yet further illustration, FIG. 2 schematically shows a social networking data processing system configured for automated filtering of content viewing rights. The system can include a host server 210 configured for communicative coupling to different client computers 220 over computer communications network 230. Each client computer 220 can include a browser client 280 accessing a social network provided by a social networking server 240 executing in the host server 210 and providing a user interface 290 to the social network.

Of note, different member profiles 260 can be specified for different members of the social network provided by the social networking server 240. Further, privacy rules 270 can be established for the members indicating when content selected for publication in the social network is to be accessible by or blocked from individual members of the social network. Importantly, automated content publication filtering module 250 can be coupled to the social networking server 240. The module 250 can include program code that when executed in the memory of the host server 240 enabled to extract a context for content selected for publication to one or more members of the social network, to provide the context to the privacy rules 270 for application to the profiles 260 in order to identify whether a member of the social network is able to view the content, or whether access to the content is to be blocked for one or more of the members of the social network.

In yet further illustration of the operation of the automated content publication filtering module, FIG. 3 is a flow chart illustrating a process for automated filtering of content viewing rights in a social network. Beginning in block 310, content can be selected for publication in the social network. In block 320, a context for the content can be computed, for example by parsing text in the content to identify key words or words pre-determined to be associated with words parsed from the content, or by speech recognizing text within audio of the content, or by image recognizing imagery in the content, or any combination thereof.

In block 330, a profile of a member of the social network otherwise able to view the content selected for publication can be retrieved. Additionally, a privacy rule can be loaded and executed against the context and the profile in order to determine in decision block 350 whether or not the member can view the selected content. If it is determined in decision block 350 that the member can view the selected content, in block 360 the content can be published for viewing by the member. Otherwise, in block 370 access to the content can be blocked. In either case, the process can be repeated as needed for other members of the social network such as those referenced in a contact list of a member directing publication of the content.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for automated filtering of content viewing rights in a social network, the method comprising:
selecting content directed for publication to different members of a social network executing in memory of a host server;
computing a context for the content;
applying a rule to the context and to at least one member profile corresponding to one of the members of the social network in order to determine whether or not the content is to be blocked from viewing by the one of the members based upon a relationship between the member profile and the computed context; and,
permitting access to the content by the one of the members when permitted by the rule.

2. The method of claim 1, wherein the context for the content is computed by parsing text from the content.

3. The method of claim 1, wherein the context for the content is computed by visually recognizing within the content.

4. The method of claim 1, wherein the rule is applied individually to all profiles corresponding to members in a contact list of a member directing publication of the content.

5. The method of claim 1, wherein the rule specifies that content of a political nature is to viewable by only those members sharing a political affiliation specified by corresponding profile information that is consistent with a political affiliation indicated by the context of the content.

6. The method of claim 1, wherein the rule specifies that content of an adult nature is to be viewable by only those members of an age specified by corresponding profile information that exceeds a minimum threshold age.

7. The method of claim 1, wherein the rule specifies that content of a profane nature is to be blocked from view by those members having a religious affiliation specified by corresponding profile information.

8. A social networking data processing system comprising:
a host server with at least one processor and memory;
a social networking server executing in the memory of the host server and providing a social network for different members over a computer communications network; and,
an automated content publication filtering module coupled to the social networking server, the module comprising program code that when executed in the memory of the host server, selects content directed for publication to different members of the social network, computes a context for the content, applies a rule to the context and to at least one member profile corresponding to one of the members of the social network in order to determine whether or not the content is to be blocked from viewing by the one of the members based upon a relationship between the member profile and the computed context, and permits access to the content by the one of the members when permitted by the rule.

9. The system of claim 8, wherein the context for the content is computed by parsing text from the content.

10. The system of claim 8, wherein the context for the content is computed by visually recognizing within the content.

11. The system of claim 8, wherein the rule is applied individually to all profiles corresponding to members in a contact list of a member directing publication of the content.

12. The system of claim 8, wherein the rule specifies that content of a political nature is to viewable by only those members sharing a political affiliation specified by corresponding profile information that is consistent with a political affiliation indicated by the context of the content.

13. The system of claim 8, wherein the rule specifies that content of an adult nature is to be viewable by only those members of an age specified by corresponding profile information that exceeds a minimum threshold age.

14. The system of claim 8, wherein the rule specifies that content of a profane nature is to be blocked from view by those members having a religious affiliation specified by corresponding profile information.

15. A computer program product for automated filtering of content viewing rights in a social network, the computer program product comprising:
a computer readable storage medium having computer readable program code embodied therewith, the computer readable program code comprising:
computer readable program code for selecting content directed for publication to different members of a social network executing in memory of a host server;
computer readable program code for computing a context for the content;
computer readable program code for applying a rule to the context and to at least one member profile corresponding to one of the members of the social network in order to determine whether or not the content is to be blocked from viewing by the one of the members based upon a relationship between the member profile and the computed context; and,
computer readable program code for permitting access to the content by the one of the members when permitted by the rule.

16. The computer program product of claim 15, wherein the context for the content is computed by parsing text from the content.

17. The computer program product of claim 15, wherein the context for the content is computed by visually recognizing within the content.

18. The computer program product of claim 15, wherein the rule is applied individually to all profiles corresponding to members in a contact list of a member directing publication of the content.

19. The computer program product of claim 15, wherein the rule specifies that content of a political nature is to viewable by only those members sharing a political affiliation specified by corresponding profile information that is consistent with a political affiliation indicated by the context of the content.

20. The computer program product of claim 15, wherein the rule specifies that content of an adult nature is to be viewable by only those members of an age specified by corresponding profile information that exceeds a minimum threshold age.

21. The computer program product of claim 15, wherein the rule specifies that content of a profane nature is to be blocked from view by those members having a religious affiliation specified by corresponding profile information.
